(19) United States
(12) Patent Application Publication
(10) Pub. No.: US 2007/0073674 A1
(43) Pub. Date: Mar. 29, 2007

(54) System and method for providing federated events for content management systems

(75) Inventors: Ryan Sean McVeigh, Broomfield, CO (US); Steven L. Roth, Westminster, CO (US); Jalpesh Patadia, Boulder, CO (US); Tanya Saarva, Boulder, CO (US); Xiaojiang Zhou, Broomfield, CO (US); Brad Posner, Erie, CO (US)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/527,173

(22) Filed: Sep. 26, 2006

Related U.S. Application Data
(60) Provisional application No. 60/720,860, filed on Sep. 26, 2005.

(51) Int. Cl. G06F 17/30

(52) U.S. Cl. 707/4

(57) ABSTRACT

A system and method for providing federated events to content management systems is described. A virtual content repository is provided that federates content from one or more underlying repositories and presents it to clients as though it were contained within one data store. The virtual content repository can include a plurality of nodes having binary property values and metadata properties. A federated event can be defined and associated with an operation in the virtual content repository. The operation can be any of create, read, update, delete, configure and other content operations. Event listeners can then be registered to receive the federated events upon an occurrence of the operation in the virtual content repository and can be further adapted to perform various programmatic functions upon receiving the event object. In this manner, federated events can provide improved system integration and maintenance for content operations across a multitude of underlying content repositories.

### CLAIM OF PRIORITY

This application claims the benefit of U.S. Provisional Patent Application 60/720,860 entitled IMPROVED CONTENT MANAGEMENT, by Ryan McVeigh et al., filed Sep. 26, 2005 (Attorney Docket No. BEAS-01968US0), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The following commonly owned, co-pending United States Patents and Patent Applications, including the present application, are related to each other. Each of the other patents/applications are incorporated by reference herein in its entirety:

U.S. patent application Ser. No. 11/438,202 entitled SYSTEM AND METHOD FOR TYPE INHERITANCE FOR CONTENT MANAGEMENT, by Ryan McVeigh et al., filed on May 22, 2006, Attorney Docket No. BEAS-1879US0;

U.S. patent application Ser. No. 11/438,593 entitled SYSTEM AND METHOD FOR PROVIDING NESTED TYPES FOR CONTENT MANAGEMENT, by Ryan McVeigh et al., filed on May 22, 2006, Attorney Docket No. BEAS-1880US0;

U.S. patent application Ser. No. 11/438,164 entitled SYSTEM AND METHOD FOR PROVIDING LINK PROPERTY TYPES FOR CONTENT MANAGEMENT, by Ryan McVeigh et al., filed on May 22, 2006, Attorney Docket No. BEAS-1881US0; and

U.S. patent application Ser. No. XX/XXX,XXX entitled SYSTEM AND METHOD FOR PROVIDING FULL TEXT SEARCHING OF MANAGED CONTENT, by Ryan McVeigh et al., filed on September 26, 2006, Attorney Docket No. BEAS-1 877US0.

U.S. patent application Ser. No. XX/XXX,XXX entitled SYSTEM AND METHOD FOR USING SOFT LINKS TO MANAGED CONTENT, by Ryan McVeigh et al., filed on Sep. 26, 2006, Attorney Docket No. BEAS-1884US0.

### FIELD OF THE INVENTION

The current invention relates generally to managing content for use with portals and other content delivery mechanisms, and more particularly to a mechanism for providing federated events and behavior tracking for managed content.

### BACKGROUND

Content repositories manage and provide access to large data stores such as a newspaper archives, advertisements, inventories, image collections, etc. A content repository can be a key component of a web application such as a portal, which must quickly serve up different types of content in response to user interaction. However, difficulties can arise when trying to integrate more than one vendor's content repository. Each may have its own proprietary application program interface and content services (e.g., conventions for searching and manipulating content, versioning, lifecycles, and data formats). Furthermore, each time a repository is added to an application, the application software must be modified to accommodate these differences. What is needed is a coherent system and method for interacting with disparate repositories and for providing a uniform set of content services across all repositories, including those that lack such services.

### BRIEF DESCRIPTION OF THE DRAWINGS

FIG. 1 is an illustration of functional system layers in various embodiments.

FIG. 2 is an illustration of objects/interfaces that can be used to interface repositories comprising content in various embodiments.

FIG. 3 is an exemplary illustration of the objects and interfaces that enable a set of federated events to be provided for a content management system, in accordance with various embodiments.

FIG. 4A is an exemplary flow diagram illustration of the functionality of federated events in accordance with various embodiments.

FIG. 4B is a flow diagram illustration of an exemplary use case for federated events in accordance with various embodiments.

FIG. 5 is a hardware block diagram of an example computer system, which may be used to embody one or more components in an embodiment.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with embodiments, there are provided mechanisms and methods for providing federated events to content management systems. A virtual content repository is provided that federates content from one or more underlying repositories and presents it to clients as though it were contained within one data store. The virtual content repository can include a plurality of nodes having binary property values and metadata. A federated event can be defined and associated with an operation in the virtual content repository. The operation can be any of create, read, update, delete, configure, as well as other content operations. Event listeners can then be registered to receive the federated events upon an occurrence of the operation in the virtual content repository and can be further adapted to perform various programmatic functions upon receiving the event object. In this manner, federated events can provide improved system integration and maintenance for content operations across a multitude of underlying content repositories.

As used herein, the term inheritance (or extension) is defined as when an object extends or inherits from a parent object, it gains the functionality as described by that parent object. The object is also capable of modifying that functionality to suit the object's specific needs. For content types, the functionality that can be extended and/or modified is the parent type's property definitions. As used herein, the term subtype is defined as a content type that has extended another content type. This is typically the child in the parent-child relationship. As used herein, the term Supertype (or Base Type) is defined as a content type that has been extended by another content type. This is typically the parent in the parent-child relationship. As used herein, the term overload is defined as the process by which a user modifies a property definition specified by a supertype. As used herein, the term abstract type is defined as a type that cannot be “instantiated”. A user cannot create a node of an abstract type. An abstract type may serve to be extended by other types (which could then have nodes instantiated) or a nested type within another type. As used herein, the term container type is defined as a type that contains other types as part of its data model. As used herein, the term contained type is defined as a type that is modeled within another type. This is done by the container type creating a property definition of type “nested type” which refers to the type to be nested. As used herein, the term container instance is defined as a node that is an instance of a container type. As used herein, the term contained instance is defined as a “node” that represents the property values of the nested property type within a container node. As used herein, the term link property type is defined as type of property definition that specifies a link to another node in the content management system. As used herein, the term link source is defined as the node containing the link property type property. As used herein, the term link target is defined as the target node to which a link source node's link property refers. Multiple link source nodes may reference the same target node. Further, link sources can target multiple link target nodes.

While the present invention is described with reference to an embodiment in which techniques for providing federated events are implemented in an application server in conformance with the J2EE Management Framework using executable programs written in the Java™ programming language, the present invention is not limited to the J2EE Management Framework nor the Java™ programming language. Embodiments may be practiced using other interconnectivity specifications or programming languages, i.e., JSP and the like without departing from the scope of the embodiments claimed. (Java™ is a trademark of Sun Microsystems, Inc.).

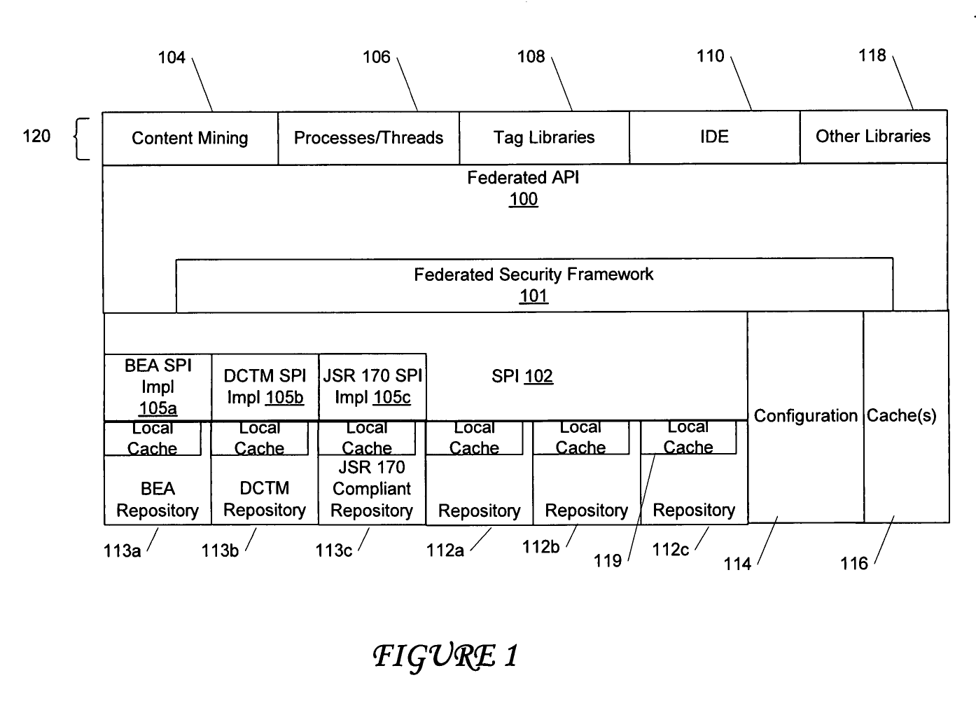

FIG. 1 is an illustration of functional system layers in various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

A content repository 112 represents a searchable data store. Such systems can relate structured content and unstructured content (e.g., digitally scanned paper documents, Extensible Markup Language, Portable Document Format, Hypertext Markup Language, electronic mail, images, video and audio streams, raw binary data, etc.) into a searchable corpus. Content repositories can be coupled to or integrated with content management systems. Content management systems can provide for content workflow management, versioning, content review and approval, automatic content classification, event-driven content processing, process tracking and content delivery to other systems. By way of illustration, if a user fills out a loan application on a web portal, the portal can forward the application to a content repository which, in turn, can contact a bank system, receive notification of loan approval, update the loan application in the repository and notify the user by rendering the approval information in a format appropriate for the web portal.

A virtual or federated content repository (hereinafter referred to as “VCR”) is a logical representation of one or more individual content repositories. For example, the VCR provides a single access point to multiple repositories from the standpoint of application layer 120 but does not shield from the user that there is more than one repository available. The VCR can also add content services to repositories that natively lack them. Typically, the user interacts with the VCR by specifying which repository an action is related to (such as adding a new node), or performing an action that applies to all repositories (such as searching for content). In various embodiments and by way of illustration, this can be accomplished in part by use of an API (application program interface) 10 and an SPI (service provider interface) 102. An API describes how entities in the application layer can interface with some program logic or functionality. The application layer can include applications (and subdivisions thereof) that utilize the API, such as processes, threads, servlets, portlets, objects, libraries, and other suitable application components. An SPI describes how a service provider (e.g., a content repository, a content management system) can be integrated into a system of some kind. The SPI isolates direct interaction with repositories from the API. In various embodiments, this can be accomplished at run-time wherein the API library dynamically links to or loads the SPI library. In another embodiment, the SPI can be part of a server process such that the API and the SPI can communicate over a network. The SPI can communicate with the repositories using any number of means including, but not limited to, shared memory, remote procedure calls and/or via one or more intermediate server processes.

Content repositories may comprise a variety of interfaces for connecting with the repository. For example, as shown in FIG. 1, a BEA format repository 113a provided by BEA Systems, Inc. of San Jose, Calif., a Documentum format repository 113b, provided by EMC Corp. of Hopkinton, Mass., and a JSR-170 compliant repository 113c may be integrated into a VCR and made accessible via a single federated API 100 by SPI 102. Individual SPI implementations 105a, 105b, 105c provide format specific service provider interfaces to the BEA format repository 113a, the Documentum format repository 113b, and the JSR-170 format repository 113c, respectively. It is noteworthy that not all of the formats illustrated in FIG. 1 will be present in all embodiments. Further, some embodiments will include other repository formats not illustrated by FIG. 1 for brevity.

API's and SPI's can be specified as a collection of classes/interfaces, data structures and/or methods/functions that work together to provide a programmatic means through which VCR service(s) can be accessed and utilized. By way of illustration, APIs and SPIs can be specified in an object-oriented programming language, such as Java™ (available from Sun Microsystems, Inc. of Mountain View, Calif.) and C# (available from Microsoft Corp. of Redmond, Wash.). The API and SPI can be exposed in a number of ways, including but not limited to static libraries, dynamic link libraries, distributed objects, servers, class/interface instances, and other suitable means.

In various embodiments, the API presents a unified view of all repositories to the application layer such that navigation, CRUD operations (create, read, update, delete), versioning, workflows, and searching operations initiated from the application layer operate on the repositories as though they were one. Repositories that implement the SPI can “plug into” the VCR. The SPI includes a set of interfaces and services that support API functionality at the repository level. The API and SPI share a content model that represents the combined content of all repositories as a hierarchical namespace of nodes. Given a node N, nodes that are hierarchically inferior to N are referred to as children of N, whereas nodes that are hierarchically superior to N are referred to as parents of N. The top-most level of the hierarchy is termed the federated root. There is no limit to the depth of the hierarchy. In various embodiments, repositories are children of the federated root. Each repository can itself have children.

By way of illustration, content mining facilities 104, processes/threads 106, tag libraries 108, integrated development environments (IDEs) 110, and other libraries 118 can all utilize the API to interact with a VCR. An IDE can provide the ability for a user to interactively build workflows and/or content views. Content mining facilities can include services for automatically extracting content from the VCR based on parameters. Java Serverpages™ tag libraries enable portals to interact with the VCR and surface its content on web pages. (Java ServerPages™ is available from Sun Microsystems, Inc.) In addition, it will be apparent to those of skill in the art that many other types of applications and software components utilize the API and are, as such, fully within the scope and spirit of the present disclosure.

In various embodiments, the API can include optimizations to improve the performance of interacting with the VCR. One or more caches 116 can be used to buffer search results and/or recently accessed nodes. Some implementations may include additional cache 119 in one or more repositories. In various embodiments, a cache can include a node cache and/or a binary cache. A node cache can be used to provide fast access to recently accessed nodes whereas a binary cache can be used to provide fast access to the binary content/data associated with each node in a node cache. The API can also provide a configuration facility 114 to enable applications, tools and libraries to configure caches and the VCR. In various embodiments, this facility can be can be configured via Java Management Extension (JMX) (available from Sun Microsystems, Inc.).

In various embodiments, a model for representing hierarchy information, content and data types is shared between the API and the SPI. In this model, a node can represent hierarchy information, content or schema information. Hierarchy nodes can serve as containers for other nodes in the namespace akin to a file subdirectory in a hierarchical file system. Schema nodes represent predefined data types. Content nodes represent content/data. Nodes can have a shape defined by their properties. A property associates a name, a data type and an optional value that is appropriate for the type. In certain of these embodiments, the properties of content nodes contain values. By way of an illustration, a type can be any of the types described in Table 1. Those of skill in the art will appreciate that many more types are possible and fully within the scope and spirit of the present disclosure.

TABLE 1
Exemplary Property Types in Various Embodiments

| PROPERTY | |
|---|---|
| TYPE | DESCRIPTION |
| Basic | Text, a number, a date/time, a Boolean value, |
| | a choice, an image, a sound, a bit mask, an |
| | audio/visual presentation, binary data. |
| Link | A pointer/reference to data that lives “outside” |
| | of a node. |
| Lookup | An expression to be evaluated for locating another |
| | node in the VCR |
| Database Mapped | Maps to an existing database table or view. |
| (or schema) | |
| Nested | One or more schemas define individual properties. |

In various embodiments, a property can also indicate whether it is required, whether it is read-only, whether it provides a default value, and whether it specifies a property choice. A property choice indicates if a property is a single unrestricted value, a single restricted value, a multiple unrestricted value, or a multiple restricted value. Properties that are single have only one value whereas properties that are multiple can have more than one value. If a property is restricted, its value(s) are chosen from a finite set of values. But if a property is unrestricted, any value(s) can be provided for it. A property can also be designated as a primary property. By way of illustration, the primary property of a node can be considered its default content. For example, if a node contained a binary property to hold an image, it could also contain a second binary property to represent a thumbnail view of the image. If the thumbnail view was the primary property, software applications such as browser could display it by default.

A named collection of one or more property types is a schema. A schema node is a place holder for a schema. In various embodiments, schemas can be used to specify a node's properties. By way of illustration, a Person schema with three properties (Name, Address and DateofBirth) can be described for purposes of discussion as follows:

Schema Person = {

<Name=Name, Type=Text>,
<Name=Address, Type=Address>,
<Name=DateofBirth, Type=Date>}

Various embodiments allow a node to be defined based on a schema. By way of illustration, a content node John can be given the same properties as the schema Person:
Content Node John is a Person

In this case, the node John would have the following properties: Name, Address and DateofBirth. Alternatively, a node can use one or more schemas to define individual properties. This is sometimes referred to as nested types. In the following illustration, John is defined having an Info property that itself contains the properties Name, Address and DateofBirth. In addition, John also has a CustomerId property:

Content Node John = {

<Name=Info, Type=Person>,
<Name=CustomerId, Type=Number> }

Schemas can be defined logically in the VCR and/or in the individual repositories that form the VCR. In certain embodiments, schemas can inherit properties from at least one other schema. Schema inheritance can be unlimited in depth. That is, schema A can inherit from schema B, which itself can inherit from schema C, and so on. If several schemas contain repetitive properties, a “base” schema can be configured from which the other schemas can inherit. For example, a Person schema containing the properties Name, Address and DateofBirth, can be inherited by an Employee schema which adds its own properties (i.e., Employee ID, Date ofHire and Salary):

```
Schema Employee inherits from Person = {
      <Name=EmployeelD, Type= Number>,
      <Name=DateofHire, Type=Date>,
      <Name=Salary, Type= Number> }
```

Thus, as defined above the Employee schema has the following properties: Name, Address, DateofBirth, EmployeeID, DateofHire and Salary. If the Person schema had itself inherited properties from another schema, those properties would also belong to Employee.

In various embodiments, nodes have names/identifiers and can be specified programmatically or addressed using a path that designates the node's location in a VCR namespace. By way of illustration, the path can specify a path from the federated root (‘/’) to the node in question (‘c’):
/a/b/c

In this example, the opening ‘/’ represents the federated root, ‘a’ represents a repository beneath the federated root, ‘b’ is a hierarchy node within the ‘a’ repository, and ‘c’ is the node in question. The path can also identify a property (“property1”) on a node:
/a/b/c.property1

In aspects of these embodiments, the path components occurring prior to the node name can be omitted if the system can deduce the location of the node based on context information.

In various embodiments, a schema defined in one repository or the VCR can inherit from one or more schemas defined in the same repository, a different repository or the VCR. In certain aspects of these embodiments, if one or more of the repositories implicated by an inherited schema do not support inheritance, the inheriting schema can be automatically defined in the VCR by the API. In one embodiment, the inheriting schema is defined in the VCR by default.

By way of illustration, the Employee schema located in the Avitech repository inherits from the Person schema located beneath the Schemas hierarchy node in the BEA repository:

Schema /Avitech/Employee inherits from /BEA/Schemas/Person = {

<Name=EmployeeID, Type= Number>,
<Name=DateofHire, Type=Date>,
<Name=Salary, Type= Number> }

In various embodiments, the link property type (see Table 1) allows for content reuse and the inclusion of content that may not be under control of the VCR. By way of illustration, the value associated with a link property can refer/point to any of the following: a content node in a VCR, an individual property on a content node in a VCR, a file on a file system, an object identified by a URL (Uniform Resource Locator), or any other suitable identifier. In various embodiments, when editing a content node that has a link property type, a user can specify the link destination (e.g., using a browser-type user interface). In certain aspects of these embodiments, if a link refers to a content node or a content node property that has been moved, the link can be resolved automatically by the system to reflect the new location.

In various embodiments, a value whose type is lookup (see Table 1) can hold an expression that can be evaluated to search the VCR for instances of content node(s) that satisfy the expression. Nodes that satisfy the expression (if any) can be made available for subsequent processing. In various embodiments, a lookup expression can contain one or more expressions that can substitute expression variables from: the content node containing the lookup property, a user profile, anything in the scope of a request or a session. In various embodiments, an expression can include mathematical, logical and Boolean operators, function/method invocations, macros, SQL (Structured Query Language), and any other suitable query language. In various embodiments, an expression can be pre-processed one or more times to perform variable substitution, constant folding and/or macro expansion. It will be apparent to those of skill in the art that many other types of expressions are possible and fully within the scope and spirit of this disclosure.

In various embodiments, when editing a content node that has a lookup property type, the user can edit the expression through a user interface that allows the user to build the expression by either entering it directly and/or by selecting its constituent parts. In addition, the user interface can enable the user to preview the results of the expression evaluation.

Database mapped property types (see Table 1) allow information to be culled (i.e., mapped) from one or more database tables (or other database objects) and manipulated through node properties. By way of illustration, a company might have “content” such as news articles stored as rows in one or more RDBMS (Relational Database Management System) tables. The company might wish to make use of this “content” via their portal implementation. Further, they might wish to manage the information in this table as if it existed in the VCR. Once instantiated, a content node property that is of the database mapped type behaves as though its content is in the VCR (rather than the database table). In one embodiment, all API operations on the property behave the same but ultimately operate on the information in the database table.

In various embodiments, a given database mapped property type can have an expression (e.g., SQL) which, when evaluated, resolves to a row and a column in a database table (or resolves to any kind of database object) accessible by the system over one or more networks. A database mapped property will be able to use either native database tables/objects or database views on those tables/objects. It will be appreciated by those of skill in the art that the present disclosure is not limited to any particular type of database or resolving expression.

In aspects of certain embodiments, a schema can be automatically created that maps to any row in a database table. The system can inspect the data structure of the table and pre-populate the schema with database mapped properties corresponding to columns from the table. The table column names can be used as the default property names and likewise the data type of each column will determine the data type of each corresponding property. The system can also indicate in the schema which properties correspond to primary key columns. If certain columns from the table are not to be used in the new schema, they can be un-mapped (i.e. deselected) by a user or a process. A content node can be based on such a schema and can be automatically bound to a row in a database table (or other database object) when it is instantiated. In various embodiments, a user can interactively specify the database object by browsing the database table.

While not required by all embodiments, some embodiments employ a display template (or “template”) to display content based on a schema. Templates can implement various “views”. By way of illustration, views could be “full”, “thumbnail”, and “list” but additional “views” could be defined by end-users. A full view can be the largest, or full page view of the content. A thumbnail view would be a very small view and a list view can be used when displaying multiple content nodes as a “list” on the page (e.g., a product catalog search results page). In various embodiments, the association between a schema and templates can be one-to-many. A template can be designated as the default template for a schema. In certain of these embodiments, templates can be designed with the aid of an integrated development environment (IDE). It is noteworthy that template technology is not limited to web applications. Other delivery mechanisms such as without limitation mobile phones, XML, and the like can be enabled by this technology.

In various embodiments and by way of illustration, display templates can be implemented using HTML (Hypertext Markup Language) and JSP (Java® Server Pages). By way of a further illustration, such a display template can be accessed from a web page through a JSP tag that can accept as an argument the identifier of a content node. Given the content node, the node's schema and associated default display template can be derived and rendered. Alternatively, the JSP tag can take an additional argument to specify a view other than the default. In another embodiment, display templates can be automatically generated (e.g., beforehand or dynamically at run-time) based on a content node's schema. In other embodiments, the view (e.g., full, thumbnail, list) can be determined automatically based on the contents of an HTTP request.

In various embodiments, a role is a dynamic set of users. By way of illustration, a role can be based on functional responsibilities shared by its members. In aspects of these embodiments, a role can be defined by one or more membership criteria. Role mapping is the process by which it is determined whether or not a user satisfies the membership criteria for a given role. For purposes of discussion, a role can be described as follows:
Role=PMembers+[Membership Criteria]

where PMembers is a set of user(s), group(s) and/or other role(s) that form a pool of potential members of this role subject to the Membership Criteria, if any. A user or a process can be in a role, if that user or process belongs to PMembers or satisfies the Membership Criteria. It is noteworthy that a user or process does not need to be a member of PMembers to be considered a member of the role. For example, it is possible to define a role with a criterion such as: “Only on Thursdays” as its membership criteria. All users would qualify as a member of this role on Thursdays. The Membership Criteria can include one or more conditions. By way of illustration, such conditions can include, but are not limited to, one or more (possibly nested and intermixed) Boolean, mathematical, functional, relational, and/or logical expressions. By way of illustration, consider the following Administrator role:
Administrator=Joe, Mary, SuperUser+CurrentTime>5:00 pm

The role has as its potential members two users (Joe and Mary) and users belonging to the user group named SuperUser. The membership criteria includes a condition that requires the current time to be after 5:00 pm. Thus, if a user is Joe, Marry or belongs to the SuperUser group, and the current time is after 5:00 pm, the user is a member of the Administrator role.

In various embodiments, roles can be associated with Resource(s). By way of illustration, a resource can be any system and/or application asset (e.g., VCR nodes and node properties, VCR schemas and schema properties, operating system resources, virtual machine resources, J2EE application resources, and any other entity that can be used by or be a part of software/firmware of some kind). Typically, resources can be arranged in one or more hierarchies such that parent/child relationships are established (e.g., the VCR hierarchical namespace and the schema inheritance hierarchy). In certain of these embodiments, a containment model for roles is followed that enables child resources to inherit roles associated with their parents. In addition, child resources can override their parents' roles with roles of their own.

In various embodiments, Membership Criteria can be based at least partially on a node's properties. This allows for roles that can compare information about a user/process to content in the VCR, for example. In various embodiments, a node's property can be programmatically accessed using dot notation: Article.Creator is the Creator property of the Article node. By way of illustration, assume an Article node that represents a news article and includes two properties: Creator and State. A system can automatically set the Creator property to the name of the user that created the article. The State property indicates the current status of the article from a publication workflow standpoint (e.g., whether the article is a draft or has been approved for publication). In this example, two roles are defined (see Table 2).

TABLE 2
Exemplary Roles in an Embodiment

| ROLE | ASSOCIATED | | MEMBERSHIP |
|---|---|---|---|
| NAME | WITH | PMEMBERS | CRITERIA |
| Submitter | Article | Article.Creator | Article.State = Draft |
| Approver | Article | Editor | Article.State = |
| | | | (Submitted or |
| | | | Approved) |

The Submitter and Approver roles are associated with the Article node. Content nodes instantiated from this schema will inherit these roles. If a user attempting to access the article is the article's creator and the article's state is Draft, the user can be in the Submitter role. Likewise, if a user belongs to an Editor group and the article's state is Submitted or Approved, then the user can belong to the Approver role.

In various embodiments, a policy can be used to determine what capabilities or privileges for a given resource are made available to the policy's Subjects (e.g., user(s), group(s) and/or role(s)). For purposes of discussion, a policy can be described as follows:

Policy = Resource + Privilege(s) + Subjects +

[Policy Criteria]

Policy mapping is the process by which Policy Criteria, if any, are evaluated to determine which Subjects are granted access to one or more Privileges on a Resource. Policy Criteria can include one or more conditions. By way of illustration, such conditions can include, but are not limited to, one or more (possibly nested and intermixed) Boolean, mathematical, functional, relational, and/or logical expressions. Aspects of certain embodiments allow policy mapping to occur just prior to when an access decision is rendered for a resource.

Similar to roles, in certain of these embodiments a containment model for policies is followed that enables child resources to inherit policies associated with their parents. In addition, child resources can override their parents' polices with policies of their own.

In various embodiments, policies on nodes can control access to privileges associated with the nodes. By way of illustration, given the following policies:

Policy1 = Printer504 + Read/View + Marketing
Policy2 = Printer504 + All + Engineering

the Marketing role can read/view and browse the Printer504 resource whereas the Engineering role has full access to it (“All”). These privileges are summarized in Table 3. Policy1 allows a user in the Marketing role to merely view the properties of Printer504 whereas Policy2 allows a user in the Engineering role to view and modify its properties, to create content nodes based on Printer504 (assuming it is a schema), and to delete the resource.

TABLE 3
Exemplary Privileges for a “Printer504” Node
in Various Embodiments

| | | READ/ | | | |
|---|---|---|---|---|---|
| ROLE | CREATE | VIEW | UPDATE | DELETE | BROWSE |
| Marketing | | X | | | x |
| Engineering | x | X | X | X | x |

Aspects of certain of these embodiments include an implied hierarchy for privileges wherein child privilege(s) of a parent privilege are automatically granted if the parent privilege is granted by a policy.

In various embodiments, the containment models for polices and roles are extended to allow the properties of a node to inherit the policies and roles that are incident on the node. Roles/polices on properties can also override inherited roles/polices. For purposes of illustration, assume the following policy on a Power property of Printer504:
Policy3=Printer504.Power+Update+Marketing

In Policy3, the Marketing role is granted the right to update the Power property for the printer resource Printer504 (e.g., control whether the printer is turned on or off). By default, the Read/View property is also granted according to an implied privilege hierarchy. (There is no Browse privilege for this property.) See Table 4. Alternatively, if there was no implied privilege hierarchy, the Power property would inherit the read/view privilege for the Marketing role from its parent, Printer504. Although no policy was specified for the Power property and the Engineering role, the privileges accorded to the Engineering role can be inherited from a parent node. These privileges are summarized in Table 4.

TABLE 4
Exemplary Privileges for the “Power” Property
in the “Printer504” Node

| ROLE | CREATE | READ/VIEW | UPDATE | DELETE |
|---|---|---|---|---|
| Marketing | | X | x | |
| Engineering | X | X | x | x |

In various embodiments, the ability to instantiate a node based on a schema can be privileged. This can be used to control which types of content can be created by a user or a process. By way of illustration, assume the following policy:
Policy4=Press_Release+Instantiate+Marketing, Manager

Policy4 specifies that nodes created based on the schema Press_Release can only be instantiated by users/processes who are members of the Marketing and/or Manager roles. In aspects of certain of these embodiments, user interfaces can use knowledge of these policies to restrict available user choices (e.g., users should only be able to see and choose schemas on which they have the Instantiate privilege).

In various embodiments, policies can be placed on schemas. For purposes of illustration, assume the following policies:

Policy5 = Press_Release + Read/View + Everyone
Policy6 = Press_Release + All + Public_Relations

TABLE 5
Exemplary Privileges for the “Press Release” Schema

| | CREATE | READ/ | | | |
|---|---|---|---|---|---|
| ROLE | INSTANCE | VIEW | UPDATE | DELETE | BROWSE |
| Everyone | | X | | | x |
| Public | X | X | X | x | x |
| Relations | | | | | |

With reference to Table 5 and by way of illustration, assume a content node instance was created based on the Press Release schema. By default, it would have the same roles/polices as the Press Release schema. If a policy was added to the node giving a role “Editor” the privilege to update the node, the result would be additive. That is, Everyone and Public Relations would maintain their original privileges.

In various embodiments, policies can be placed on properties within a schema, including property choices. (Property choices are a predetermined set of allowable values for a given property. For example, a “colors” property could have the property choices “red”, “green” and “blue”.)

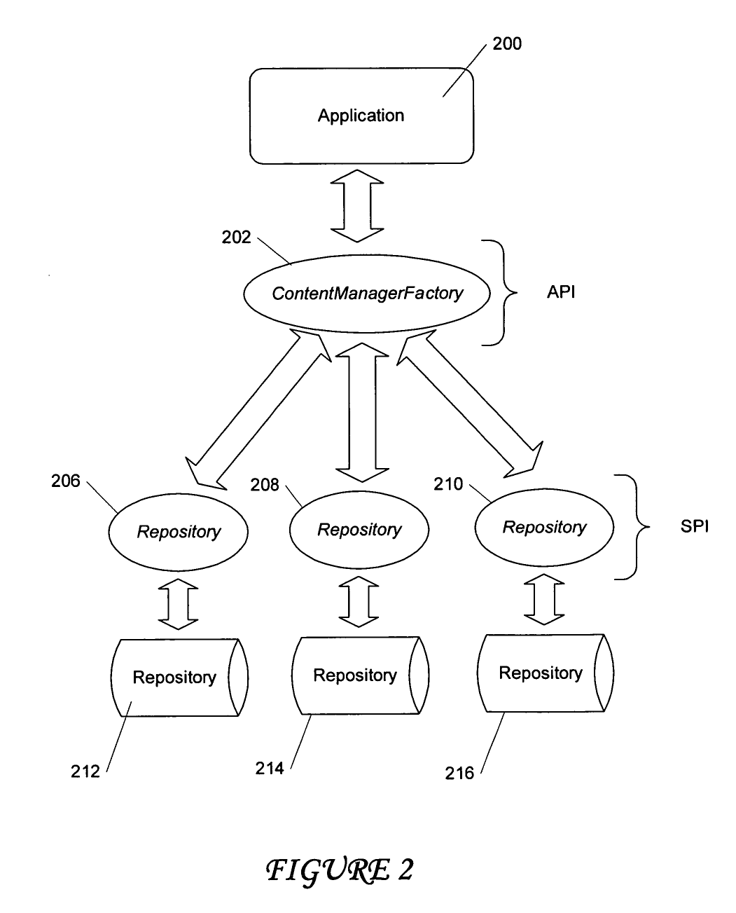

FIG. 2 is an illustration of objects/interfaces that can be used to interface repositories comprising content in various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

The ContentManagerFactory 202 can serve as a representation of an access device from an application program's 200 point of view. In aspects of these embodiments, the ContentManagerFactory attempts to connect all available repositories to the device (e.g., 212-216); optionally with user or process credentials. In various embodiments, this can be based on the Java™ Authentication and Authorization Service (available from Sun Microsystems, Inc.). Those of skill in the art will recognize that many authorization schemes are possible without departing from the scope and spirit of the present disclosure. An SPI Repository object 206-210 represents each available content repository. In an embodiment, the ContentManagerFactory can invoke a connect( ) method on the set of Repository objects. It is noteworthy that, in some embodiments, the notion of “connecting” to a repository is not exposed to users. In various embodiments, the ContentManagerFactory returns a list of repository session objects to the application program, one for each repository for which a connection was attempted. Any error in the connection procedure can be described by the session object's state. In another embodiment, the ContentManagerFactory can connect to a specific repository given the repository name. In various embodiments, the name of a repository can be a URI (uniform resource identifier).

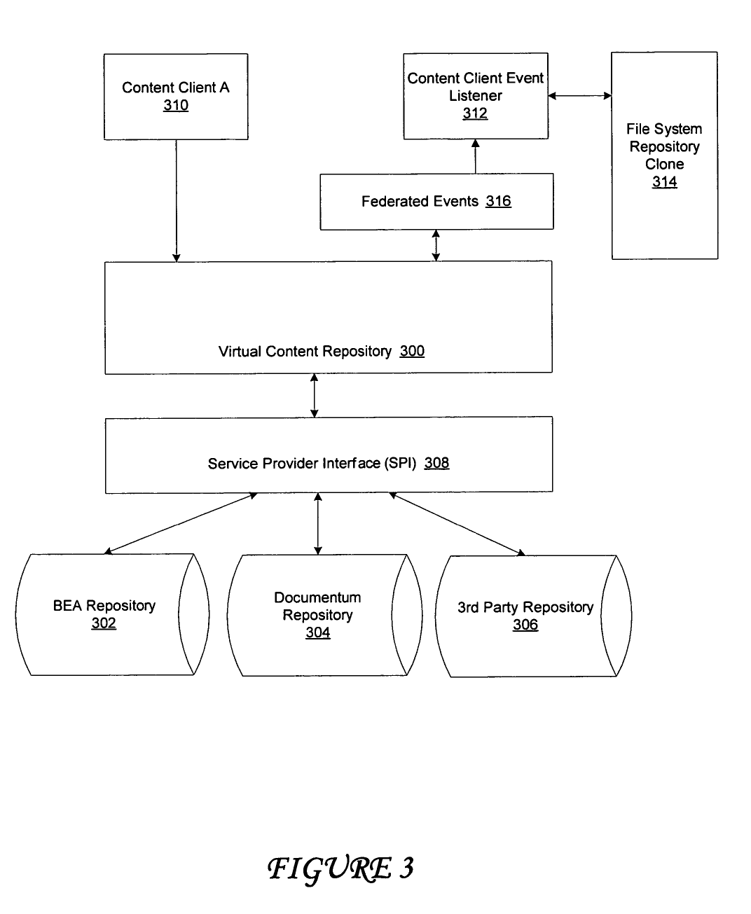

FIG. 3 is an exemplary illustration of the objects and interfaces that enable a set of federated events to be provided for a content management system, in accordance with various embodiments. Although this diagram may depict components as logically separate, such depiction is merely for illustrative purposes. It will be apparent to those skilled in the art that the components portrayed in this or other figures can be combined or divided into separate software, firmware and/or hardware components. Furthermore, it will also be apparent to those skilled in the art that such components, regardless of how they are combined or divided, can execute on the same computing device or can be distributed among different computing devices connected by one or more networks or other suitable communication means.

As illustrated, the virtual content repository 300 can combine multiple stores of data such and present them as a single content repository to the various content repository clients 310 and 312. For example, a single enterprise can maintain its data in multiple heterogeneous repositories, such as BEA Content repository 302, Documentum content repository 304, and various other third party repositories 306. The virtual content repository 300 can bring together and present all of the content in these repositories by allowing them to plug into the service provider interface (SPI) 308 of the VCR. As previously discussed, the SPI describes how a service provider can be integrated into a system and isolates direct interaction with repositories from the API.

Content repository clients such as client A 310 can access, read, delete, update and perform various other operations on content by using the API of the virtual content repository. In this manner, developers can be shielded from having to know each interface and other data store specifics of the underlying content repositories. As an illustration, via the use of the virtual content repository, client A 310 may update a content node within the BEA repository and add new content nodes to the Documentum repository as though they were a single data store.

In various embodiments, set of federated events and listeners 316 can be provided for the virtual content repository 300. As clients use the API of the virtual content repository, corresponding events can be generated and event listeners can register for these events to be notified synchronously or asynchronously and perform an appropriate action. This action can be specified by the developer within an enterprise. As one illustration, client A 310 can perform a CRUD operation within the virtual content repository, causing a change to the nodes therein. The federated events can then notify the content client event listener 312 of the change caused by client A to the content. It is to be understood that the event listeners are not limited by this disclosure to performing any one specific programming operation. For example, in alternative embodiments, the event listeners may instead write information about the CRUD operation to an external database or perform some other action. Similarly, the federated events need not necessarily be triggered by a CRUD operation, but instead could be dispatched whenever a new repository is created, configured or whenever various other actions occur. These are system-specific details which can be made configurable by a developer, user or system administrator. It should further be noted that the content could physically reside at any of the underlying repositories 302, 304, 306, however, because they all plug into the virtual content repository, the federated events can be dispatched and registered as though all of the content was maintained in one data store.

The federated events can be utilized to provide for various system integration or other advantages to an enterprise. As an illustration, a proxy server can maintain a very fast access clone of the content repository, by for example storing the data on the file system 314. The set of federated events can then be used to maintain and update the file system clone whenever a modification is executed within the content repository. Thus, in one embodiment, whenever client A 310 modifies content by using the VCR API, a federated event can be dispatched and events can notify the content client event listener 312 of this event. This client listener can then read the data describing the event and update the clone residing on the file system in order to keep an updated proxy server. Various other such uses are also possible.

The following table presents some user actions that can cause various events to be dispatched. It should be noted that the actions are in no way limited to this list, which is presented for illustration purposes only.

| | |
|---|---|
| Create content | User creates content in the virtual content repository |
| Delete content | User deletes content in the virtual content repository |
| Update content | User edits properties of a node, renames a node, |
| | copies a node, moves a node, associates a |
| | workflow, removes workflow association, library |
| | service operations, etc. |
| Content system | Repository modifications - create a new repository, |
| configuration | update or delete an existing repository, Content |
| | type changes - update content type, delete |
| | content type, rename content type Content workflow |
| | modifications - create workflow, update workflow, |
| | delete workflow. |

In various embodiments, information can be captured for each of the actions that cause an event to be dispatched. For example, for each content node action, event listeners may have access to any of the following information—standard tracking properties, such as user, date/time, application name, event type, as well as node ID, repository, node name, node path, type of action, destination information (for rename, move, copy) and status of a node. For content configuration operations, the listener may have access to standard tracking properties, the type of action (create repository, delete lifecycle, update content type, etc.), repository, and target. Various other types of information can be defined and captured by federated events as well.

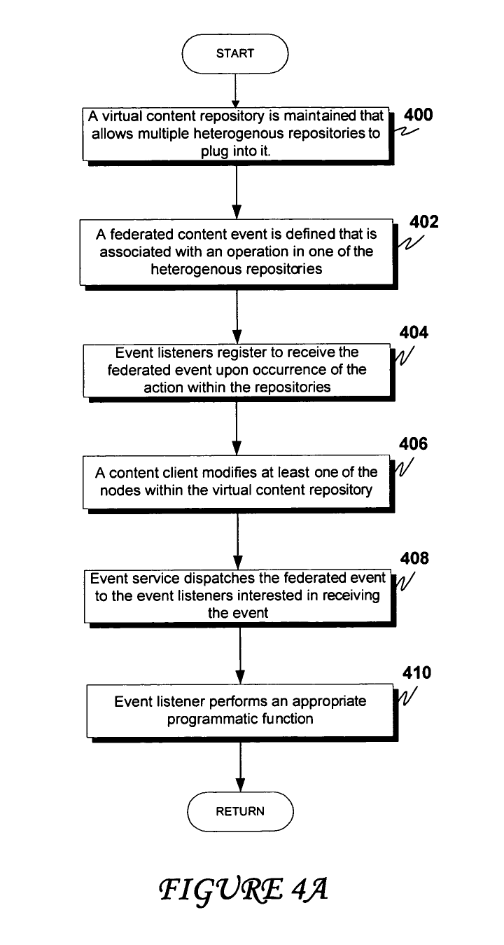

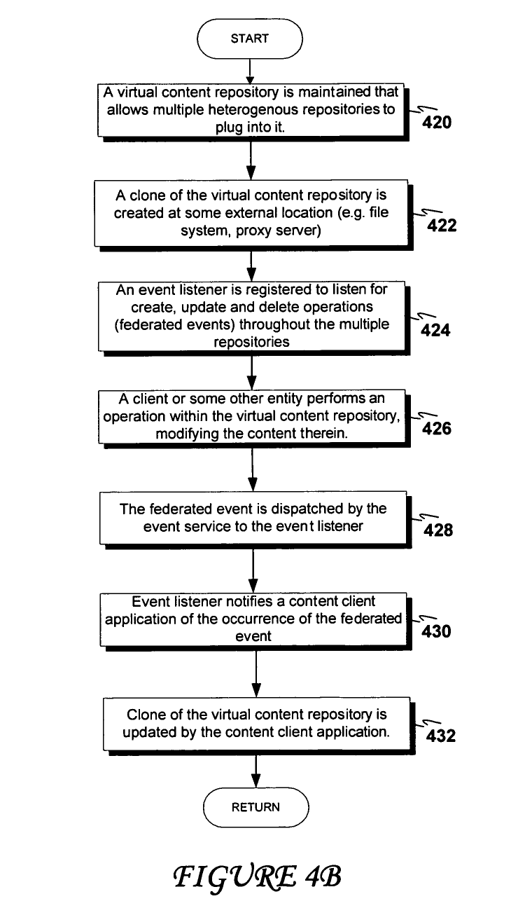

FIG. 4A is an exemplary flow diagram illustration of the functionality of federated events in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As shown in step 400, a virtual content repository is maintained in order to federate a plurality of heterogeneous data stores, as previously described. In step 402, a federated content event can be defined, that is associated with an operation or a series of operations within one of the heterogeneous repositories (via the VCR API). In one embodiment, creating a content event involves creating the Event class and optionally creating an extensible markup language (XML) Schema. An event object, including various event attributes (e.g. user_id, session_id, etc.) can be instantiated from the Event class. The XML schema, on the other hand can be used to define the XML data regarding an event, which can be stored in a database.

In step 404, a set of event listeners can register themselves to receive the federated event upon an occurrence of a specified operation within the virtual content repository. In one embodiment, an event listener serves one purpose: when an event occurs for which the listener is listening, the listener performs some type of programmatic functionality. The actions which the event listener listens for can be specified or configured by a user. For example, some event listeners may listen to all operations within the content repository, while other event listeners may monitor only one or several such operations.

In step 406, an operation is performed by a client using the virtual content repository API. This can take the form of a CRUD operation, content configuration, or any other action of interest. In step 408, an event service can dispatch the federated event associated with the operation to the appropriate event listeners. In one embodiment, dispatching an event means that the Event service sends an event object to any listeners interested in the event.

The event listeners can in turn perform a multitude of programmatic functions upon receiving the federated event. For example, one event listener may notify an external entity (e.g. a content repository client) about the event. Another event listener may record XML data about the event in a table within a database, which can be used for behavior tracking. Yet another event listener may display information to the user. The use of multiple such event listeners separately or in combination can be enabled and are well within the scope of the present disclosure.

FIG. 4B is a flow diagram illustration of an exemplary use case for federated events in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As shown in step 420, a virtual content repository is maintained in order to federate a plurality of heterogeneous data stores, as previously described. In step 422, a client application may create a clone of the virtual content repository in an external location, such as a file system. This can be done for performance reasons, such as improving data access time via a proxy server.

As shown in step 424, an event listener can be registered to listen for update, create and delete operations (federated events) throughout the multiple repositories via the use of the virtual content repository. In various embodiments, content configuration events can be supported such as creating, updating and deleting various workflows; creating, updating, deleting and renaming various content types; as well as creating, updating and deleting various underlying repositories. Content update events, on the other hand, can include rename, copy, and move; check in, check out, revert and publish; as well as associate or remove workflows. Of course, this disclosure is not limited to any specific event type and various other such event types are well within the scope of the present invention.

Subsequently, when another client performs an operation that modifies the data within the VCR (step 426), a federated event can be dispatched by the event service to that event listener (step 428). The event listener can in turn notify the client application in step 430, which can take care of updating and maintaining the clone in the external location. In this fashion, federated events can expose changes made throughout third party data stores via the use of the API and the SPI, allowing various users to perform customization through an event model. This can in turn provide for improved system integration, maintenance and updates by enterprise information systems.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the machine readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for [] as discussed herein.

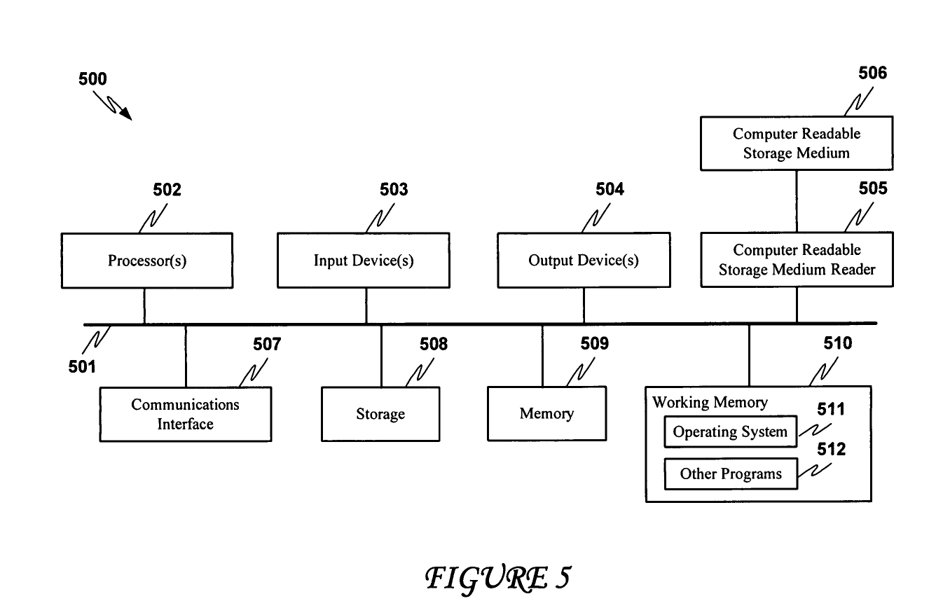

FIG. 5 illustrates a processing system 500, which can comprise one or more of the elements of FIG. 1. Turning now to FIG. 5, a computing system is illustrated that may comprise one or more of the components of FIG. 1. While other alternatives might be utilized, it will be presumed for clarity sake that components of the systems of FIG. 1 are implemented in hardware, software or some combination by one or more computing systems consistent therewith, unless otherwise indicated.

Computing system 500 comprises components coupled via one or more communication channels (e.g., bus 501) including one or more general or special purpose processors 502, such as a Pentium®, Centrino®, Power PC®, digital signal processor (“DSP”), and so on. System 500 components also include one or more input devices 503 (such as a mouse, keyboard, microphone, pen, and so on), and one or more output devices 504, such as a suitable display, speakers, actuators, and so on, in accordance with a particular application. (It will be appreciated that input or output devices can also similarly include more specialized devices or hardware/software device enhancements suitable for use by the mentally or physically challenged.)

System 500 also includes a machine readable storage media reader 505 coupled to a machine readable storage medium 506, such as a storage/memory device or hard or removable storage/memory media; such devices or media are further indicated separately as storage 508 and memory 509, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 507 may also be included, such as a modem, DSL, infrared, RF or other suitable transceiver, and so on for providing inter-device communication directly or via one or more suitable private or public networks or other components that may include but are not limited to those already discussed.

Working memory 510 further includes operating system (“OS”) 511 elements and other programs 512, such as one or more of application programs, mobile code, data, and so on for implementing system 500 components that might be stored or loaded therein during use. The particular OS or OSs may vary in accordance with a particular device, features or other aspects in accordance with a particular application (e.g. Windows®, WindowsCE™, Mac™, Linux, Unix or Palm™ OS variants, a cell phone OS, a proprietary OS, Symbian™, and so on). Various programming languages or other tools can also be utilized, such as those compatible with C variants (e.g., C++, C#), the Java™ 2 Platform, Enterprise Edition (“J2EE”) or other programming languages in accordance with the requirements of a particular application. Other programs 512 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 508 or memory 509) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for providing federated events for content management systems, said method comprising:
maintaining a virtual content repository that federates content from one or more underlying repositories, said virtual content repository including a plurality of content nodes;
defining a federated content event associated with an operation in said virtual content repository;
registering one or more event listeners to receive said federated content event upon an occurrence of said operation in said virtual content repository;
creating, modifying or removing at least one of said plurality of nodes within the virtual content repository; and
dispatching said federated content event to said one or more event listeners upon modification to said at least one of the plurality of nodes, said one or more event listeners adapted to perform a programmatic function upon receiving said federated content event.

2. The method according to claim 1, further comprising:
providing a service provider interface (SPI) for enabling a plug in point to said virtual content repository for said underlying repositories.

3. The method according to claim 1, further comprising:
providing an application programming interface (API) that presents a unified view of said underlying repositories to an application layer such that navigation, create, read, update, delete (CRUD) operations, versioning, workflows, searching, type and repository operations initiated from the application layer operate on said underlying repositories as though they were one.

4. The method according to claim 1 wherein performing a programmatic function further includes:
notifying a content repository client of the modification to said at least one of the plurality of nodes.

5. The method according to claim 1 wherein performing a programmatic function further includes:
storing data associated with said federated content event in a database.

6. The method according to claim 1 wherein said federated content event includes information regarding the operation in said virtual content repository, said information including at least one of:
a user id, date, time, application name, event type, content node id, node path, node name, type of operation, status, content type and repository name.

7. The method according to claim 1 wherein said operation in said virtual content repository includes at least any of:
create content, delete content, update content, edit properties, rename node, copy node, move node, check in content, check out content, publish content, save content, revert, configure content system, create repository, delete repository, update repository, create content type, delete content type, rename content type, create workflow, delete workflow, update workflow and associate workflow.

8. The method according to claim 1 wherein said dispatching the federated content event further includes:
sending, by an event service, an event object containing data regarding said operation within the virtual content repository.

9. A system for providing federated events to content management systems, said system comprising:
a virtual content repository that federates content from one or more underlying repositories, said virtual content repository including a plurality of content nodes;
a federated event object associated with an operation in said virtual content repository; and
one or more event listeners registered to receive said federated event object upon an occurrence of said operation in said virtual content repository wherein said one or more event listeners are adapted to perform a programmatic function upon receiving said federated event object.

10. The system according to claim 9, further comprising:
a service provider interface (SPI) for providing a plug in point to said virtual content repository for said underlying repositories.

11. The system according to claim 9, further comprising:
an application programming interface (API) that presents a unified view of said underlying repositories to an application layer such that navigation, create, read, update, delete (CRUD) operations, versioning, workflows, searching, type and repository operations initiated from the application layer operate on said underlying repositories as though they were one.

12. The system according to claim 9 wherein performing a programmatic function further includes:
notifying, by said one or more event listeners, a content repository client of the modification to said at least one of the plurality of nodes.

13. The system according to claim 9 wherein performing a programmatic function further includes:
storing, by said one or more event listeners, data associated with said federated content event in a database.

14. The system according to claim 9 wherein said federated event object includes information regarding the operation in said virtual content repository, said information including at least one of:
a user id, date, time, application name, event type, content node id, node path, node name, type of operation, status, content type and repository name.

15. The system according to claim 9 wherein said operation in said virtual content repository includes at least any of:
create content, delete content, update content, edit properties, rename node, copy node, move node, check in content, check out content, publish content, save content, revert, configure content system, create repository, delete repository, update repository, create content type, delete content type, rename content type, create workflow, delete workflow, update workflow and associate workflow.

16. The system according to claim 9, further comprising:
an event service that sends said federated event object to said one or more event listeners, said federated event object containing data regarding said operation within the virtual content repository.

17. A computer readable medium having instructions stored thereon which when executed by one or more processors, cause a system to:
maintain a virtual content repository that federates content from one or more underlying repositories, said virtual content repository including a plurality of content nodes;
define a federated content event associated with an operation in said virtual content repository;
register one or more event listeners to receive said federated content event upon an occurrence of said operation in said virtual content repository;
create, modify or remove at least one of said plurality of nodes within the virtual content repository; and
dispatch said federated content event to said one or more event listeners upon modification to said at least one of the plurality of nodes, said one or more event listeners adapted to perform a programmatic function upon receiving said federated content event.
